(19) United States
(12) Patent Application Publication
(10) Pub. No.: US 2004/0148322 A1
(43) Pub. Date: Jul. 29, 2004

(54) Radio reveiver

(76) Inventors: Eric Hertz, Angelholm (SE); Joaquin Canovas, Lund (SE); Shousheng He, Sodra Sandby (SE); Antonio Vicent, Malmo (SE)

Correspondence Address: BURNS DOANE SWECKER & MATHIS L L P, POST OFFICE BOX 1404, ALEXANDRIA, VA, 22313-1404, US

(21) Appl. No.: 10/469,248

(22) PCT Filed: Mar. 11, 2002
(86) PCT No.: PCT/EP02/02660

(30) Foreign Application Priority Data
Mar. 13, 2001 (GB) 0106162.1

(51) Int. Cl. G06F 17/10

(52) U.S. Cl. 708/300

(57) ABSTRACT

There is disclosed a radio receiver, a filter which may be used in a radio receiver, in which received signals are applied to a digital filter twice, with an intermediate time reversal. This has the effect that any phase distortion introduced by the filter is cancelled by the application of the time inverted signal to the filter. This means that a non-liner filter can be used. Specifically, in preferred embodiments of the invention, an IIR wave digital filter can be used, which means that the device can have lower power consumption and requires a smaller silicon area than would otherwise be the case.

### TECHNICAL FIELD OF THE INVENTION

This invention relates to radio receivers, and in particular to a way of filtering received signals.

### BACKGROUND OF THE INVENTION

The invention is primarily, although not exclusively, concerned with homodyne radio receivers, for example for use in time division multiple access (TDMA) communication systems and in particular with the channel filtering in such receivers. The basic demand for the filter is to obtain a good adjacent and cochannel interference performance as well as a good sensitivity performance. Since there is no IF signal filtering, baseband filtering requirements are much higher than for heterodyne receivers.

The invention is particularly, although again not exclusively, concerned with handheld portable devices, such as mobile phones. Important factors in the design of mobile terminals are the power consumption and the silicon area which is occupied by the hardware.

In order to achieve high performance, a channel filter used in a mobile phone should have linear phase, that is, no group delay variation of signals within the pass band.

This is true of receivers used in GSM devices, but other modulation schemes, such the 8-PSK modulation used in EDGE, are even more susceptible to phase distortion than the GMSK modulation used in GSM.

Current receivers typically use filters of the well-known finite impulse response (FIR) type, since they can be designed to have exactly linear phase, even after coefficient quantization. This is achieved by using filters with a symmetric impulse response.

A receiver of this type is shown in “Design of Optimal Linear-phase Transmitter and Receiver Filters for Digital Systems”, F. M. de Saint Martin and P. Siohan, IEEE International Symposium on Circuits and Systems, pp885-888, April 1995.

The disadvantage of FIR filters is that they require a much higher order than infinite impulse response (IIR) filters, to comply with a given magnitude response specification. The use of IIR structures for the receiver filter would, therefore, imply a significant improvement of the power consumption and occupied area. But traditional IIR structures have a very high sensitivity to coefficient quantization (even if realized with cascaded second order structures) and they do not achieve linear phase. In the case of a direct conversion receiver, the higher baseband filter requirements, i.e. the need to use a higher order filter, make the phase distortion a severe problem, because the higher the order of the filter, the more pronounced the phase distortion becomes.

In general, wave digital filters (WDFs) are an efficient way of implementing IIR filters, since their sensitivity to coefficient quantization is much lower. As a result, coefficients can be quantized using a much smaller number of bits. In addition, they present a very regular structure, which allows an efficient mapping to a VLSI layout.

However, as mentioned above in connection with other IIR filters, WDFs have a phase response which is far from being linear and, thus, it is not acceptable. Although, it would be desirable to linearize the phase response of the wave digital filters this has not been achieved effectively. Moreover, this may be achieved only at the expense of an increase of the filter order, which in turn means increasing the power consumption and occupied silicon area.

The present invention is concerned with providing a structure which has the performance levels of filters that are currently used, while improving the power consumption and required silicon area.

### SUMMARY OF THE INVENTION

The present invention relates to a radio receiver, and a filter which may be used in a radio receiver, in which received signals are applied to a digital filter twice, with an intermediate time reversal.

This has the effect that any phase distortion introduced by the filter is cancelled by the application of the time inverted signal to the filter. This means that a non-linear filter can be used.

Specifically, this means that, in preferred embodiments of the invention, an IIR wave digital filter can be used. The use of an IIR filter means that the device can have lower power consumption and requires a smaller silicon area than an FIR filter, while a wave digital filter typically has lower coefficient quantization sensitivity than other IIR filters, as well as good dynamic range and stability under finite-arithmetic conditions. Wave digital filters are therefore suitable for high-speed applications, and easy to implement in hardware.

The invention preferably relates in one aspect to a radio receiver, in which received signals are divided into signal blocks, with each block being filtered independently.

It should be emphasised that the term “comprises/comprising” when used in this specification is taken to specify the presence of stated features, integers, steps or components but does not preclude the presence or addition of one or more other features, integers, steps, components or groups thereof.

### BRIEF DESCRIPTION OF DRAWINGS

FIG. 1 is a block schematic diagram of a receiver in accordance with the invention.

FIG. 2 is a block schematic diagram of a filter in the receiver of FIG. 1.

### DETAILED DESCRIPTION OF PREFERRED EMBODIMENTS

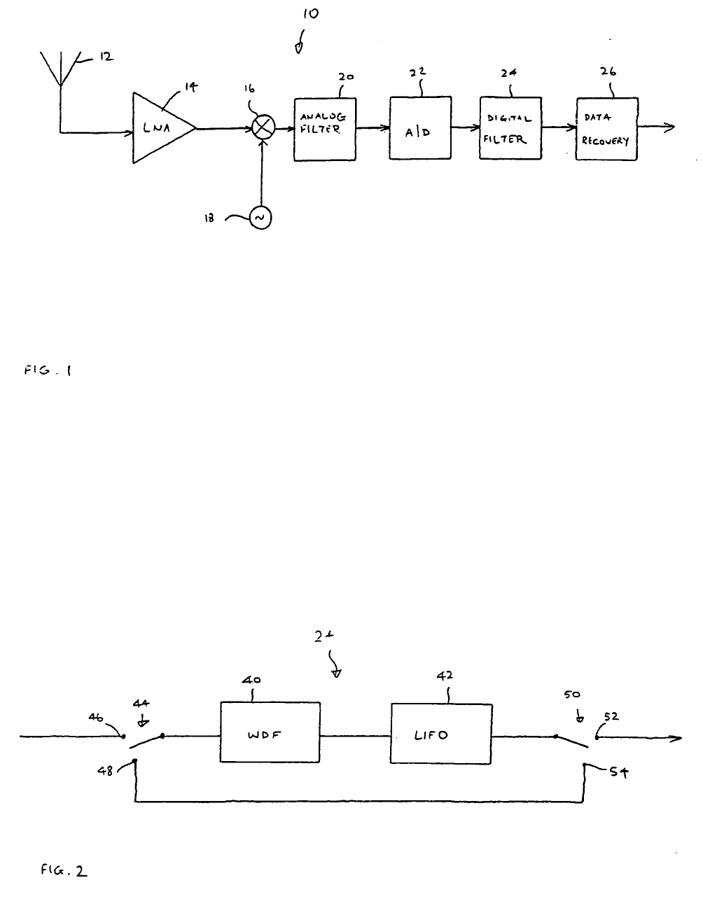

FIG. 1 is a block schematic diagram of a radio receiver in accordance with an aspect of the invention. The invention is described with reference to a receiver incorporated within a mobile radiocommunications device such as a mobile phone, but it is generally applicable to any portable radio communication equipment or mobile radio terminals, such as mobile telephones, pagers, communicators, electronic organisers, smartphones, personal digital assistants (PDAs), or the like. As will be described in more detail below, the invention is particularly applicable to receivers which operate in standards such as GSM or EDGE, in which signals can be divided into uncorrelated blocks or bursts.

The receiver 10 includes an antenna 12, which receives radio signals. Received signals are passed to a low noise amplifier LNA 14, and then to a mixer 16. The receiver is a homodyne receiver, in which a single mixer 16 receives a signal from a local oscillator 18, and downconverts the received signals to baseband.

The downconverted signals are passed to an analog filter 20. In the illustrated case of a homodyne receiver, the analog filter 20 can be a simple anti-aliasing low-pass filter, which does not contribute to the channel filtering, and hence does not introduce any significant distortion in the pass band.

The filtered signals are passed to an analog-digital converter 22. As mentioned previously, the invention is particularly applicable to receivers which operate in standards in which received signals can be divided into uncorrelated blocks (burstwise signals), such as EDGE and GSM bursts. Each block is then passed to a burst-storage memory (not shown in FIG. 1), which in many cases is available in such a receiver, since it is required by other blocks operating later in the signal processing chain. Each signal block is then passed independently to the digital filter 24, which is described more fully with reference to FIG. 2.

The filtered signals are then passed to a data recovery block 26, which extracts the EDGE/GSM data from the filtered signals.

The structure of the filter 24 is shown in FIG. 2. Specifically, the filter 24 includes a wave digital lattice filter WDF 40, and a last-in, first-out memory LIFO 42. Although the use of a wave digital lattice filter is preferred on grounds of efficiency, any filter can be used, the advantages of the invention being particularly apparent with the use of any non-linear phase digital filter, including IIR and non-symmetric FIR filters.

The filter 24 also includes a switch 44, which can connect the input of the WDF 40 either to the filter input 46 or to a return path connection 48. The filter 24 further includes a switch 50, which can connect the output of the LIFO 42 either to the filter output 52 or to another return path connection 54.

The operation of the filter 24 will now be described in more detail.

Firstly, with the switch 44 connected to terminal 46 (the position of switch 50 being irrelevant), the complete input data burst is filtered and stored in the LIFO memory. Then, the switch 44 is connected to terminal 48, and the switch 50 is connected to terminal 54, and the filtered burst is read from the LIFO. As a result, the filtered burst, time inverted, is reapplied to the same filter 40. Once again, the output from the filter 40 is stored in the LIFO memory 42. Finally, the switch 50 is connected to the terminal 52, and the contents of the LIFO are read out, having been time inverted for a second time, and supplied to the output of the filter 24.

Since the signal has been filtered once forwards and once in inverse time order, the phase distortion introduced by the filter 40 is cancelled, and the overall lattice WDF achieves a theoretical zero-phase frequency response, which means that the group delay is also set to zero. This is only possible because the time reversal of the signal is a non-causal operation, i.e. the whole burst has to be stored in the LIFO is before being read. In a practical sense, the non-causality means that the group delay is constant and equal to one burst period. (This is independent of the speed at which data are processed.) At the same time, the magnitude frequency response is squared, so this second filtering means that the lattice WDF 40 only needs to have an order which is half the order of filtering which is to be applied. Thus, the phase correction is not achieved by any phase equalizing structure, which would be irrelevant from the point of view of the filtering itself, but both applications of the filter contribute to the magnitude response, allowing the order of the IIR filter to be halved.

In the case of the WDF-based direct conversion receiver shown in FIG. 1, a 5th order WDF, with signals being applied with and without time inversion, can provide performance comparable to that of a 64th order FIR filter.

Although FIG. 2 shows signals being applied to the WDF 40 before the LIFO 42, the positions of these components can be reversed.

Moreover, although FIG. 2 shows the signals undergoing two time reversals, it is possible to have an arrangement in which the signals are applied to the wave digital filter, and then to a LIFO memory to provide a time reversal, and are then applied again to the wave digital filter. This is appropriate if the data recovery block 26 can receive time-inverted bursts, or if the filter receives time-inverted bursts, for any reason.

It will be noted that the filter shown in FIG. 2 is particularly efficient in its use hardware, since only one filter structure 40, and one LIFO 42, is needed. Further hardware efficiency is achieved, as mentioned above, by using a stack memory which is available from other parts of the system, in the case of EDGE/GSM receivers, for example.

However, at least some of the advantages of the invention, resulting from the use of IIR filters, and in particular wave digital filters, can be obtained by using a digital filter arrangement which comprises a pair of matched non-linear filters with the same coefficients.

In such an arrangement, the incoming signals are applied to the first non-linear filter, then to a LIFO memory to provide a time reversal, and then to the second non-linear filter. A second LIFO can be used, to provide an additional time reversal, either before the first non-linear filter, or after the second non-linear filter.

The embodiments described and illustrated above can be provided separately in respect of the real and imaginary components of the signals output from the A/D converter 22. Advantageously, however, the same filter arrangement, for example the filter 24 shown in FIG. 2, can be used for both the real and imaginary components.

There is thus described a filter, which has lower power consumption and a smaller occupied silicon area, than if a conventional filter is used, while avoiding distortion of the phase of the filtered bursts.

1. A filter arrangement, comprising:
an input for digital signals;
a digital filter;
a time inverter; and
switch circuitry, for applying input digital signals to the digital filter, and for applying output signals from the digital filter to the time inverter, and for reapplying the time inverted signals to the digital filter.

2. A filter arrangement as claimed in claim 1, wherein the digital filter is an infinite impulse response filter.

3. A filter arrangement as claimed in claim 2, wherein the digital filter is a wave digital filter.

4. A filter arrangement as claimed in claim 1, wherein the time inverter comprises a last-in, first-out memory.

5. A filter arrangement as claimed in claim 1, wherein the switch circuitry comprises first and second switches, each having first and second positions, the first and second switches being controlled such that:
when input digital signals are received, the first switch is in its first position, in which the input digital signals are applied to the digital filter and time inverter;
when the input digital signals have been applied to the digital filter and time inverter, the first switch is in its second position and the second switch is in its first position, in which output signals from the digital filter and time inverter are reapplied to the digital filter and time inverter; and
when the output signals from the digital filter and time inverter have been reapplied to the digital filter and time inverter, the second switch is in its second position, in which output signals from the digital filter and time inverter are supplied to an output.

6. A filter arrangement as claimed in claim 5, wherein signals are applied to the digital filter before the time inverter.

7. A filter arrangement as claimed in claim 5, wherein signals are applied to the time inverter before the digital filter.

8. A radio receiver, comprising:
analog front-end circuitry;
a digital-analog converter; and
a filter arrangement, said filter arrangement comprising:
an input for digital signals;
a digital filter;
a time inverter; and
switch circuitry, for applying input digital signals to the digital filter, and for applying output signals from the digital filter to the time inverter, and for reapplying the time inverted signals to the digital filter.

9. A radio receiver as claimed in claim 8, comprising a stack memory, for processing received signals in blocks.

10. A radio receiver as claimed in claim 8, wherein the digital filter is an infinite impulse response filter.

11. A radio receiver as claimed in claim 10, wherein the digital filter is a wave digital filter.

12. A radio receiver as claimed in claim 8, wherein the time inverter comprises a last-in, first-out memory.

13. A radio receiver as claimed in claim 8, wherein the switch circuitry comprises first and second switches, each having first and second positions, the first and second switches being controlled such that:
when input digital signals are received, the first switch is in its first position, in which the input digital signals are applied to the digital filter and time inverter;
when the input digital signals have been applied to the digital filter and time inverter, the first switch is in its second position and the second switch is in its first position, in which output signals from the digital filter and time inverter are reapplied to the digital filter and time inverter; and
when the output signals from the digital filter and time inverter have been reapplied to the digital filter and time inverter, the second switch is in its second position, in which output signals from the digital filter and time inverter are supplied to an output.

14. A radio receiver as claimed in claim 13, wherein signals are applied to the digital filter before the time inverter.

15. A radio receiver as claimed in claim 13, wherein signals are applied to the time inverter before the digital filter.

16. A method of processing received digital signals, the method comprising:
dividing the received signals into blocks;
applying each block of received signals to a digital filter;
time reversing the filtered signals; and
reapplying the time reversed signals to the digital filter.

17. A method as claimed in claim 16, further comprising time reversing the signals before applying them to the digital filter.

18. A method as claimed in claim 16, further comprising time reversing the signals after reapplying them to the digital filter.

19. A filter arrangement, comprising:
an input for digital signals;
a first digital filter, connected to receive input signals;
a time inverter, connected to receive filtered signals from the first digital filter; and
a second digital filter, being matched to the first digital filter, and connected to receive time inverted filtered signals.

20. A filter arrangement as claimed in claim 19, wherein the first and second digital filters are infinite impulse response filters.

21. A filter arrangement as claimed in claim 20, wherein the first and second digital filters are wave digital filters.

22. A filter arrangement as claimed in claim 19, wherein the time inverter comprises a last-in, first-out memory.

23. A radio receiver, comprising:
analog front-end circuitry;
a digital-analog converter; and
a filter arrangement, said filter arrangement comprising:
an input for digital signals;
a first digital filter, connected to receive input signals;
a time inverter, connected to receive filtered signals from the first digital filter; and
a second digital filter, being matched to the first digital filter, and connected to receive time inverted filtered signals.
